(19) United States
(12) Patent Application Publication
(10) Pub. No.: US 2020/0131339 A1
(43) Pub. Date: Apr. 30, 2020

(54) FILLER COMPOSITION

(71) Applicant: UBE MATERIAL INDUSTRIES, LTD., Ube-shi (JP)

(72) Inventors: Takashi IDEMITSU, Tokyo (JP); Shotaro HIDA, Tokyo (JP); Ryoichi NOMURA, Ube-shi (JP)

(21) Appl. No.: 16/732,504

(22) Filed: Jan. 2, 2020

Related U.S. Application Data
(63) Continuation of application No. 15/769,972, filed on Apr. 20, 2018.

(30) Foreign Application Priority Data
Oct. 23, 2015 (JP) 2015-209059

(51) Int. Cl. C08K 7/04; C08K 3/22; C01F 5/40; C08K 3/00; C08K 3/30; C08K 3/26; C08K 7/08

(52) U.S. Cl. CPC C08K 7/04; C08K 3/22; C01F 5/40; C08K 3/00; C08K 3/30; C08K 3/26; C08K 3/013; C08K 2003/222; C08K 2003/2224; C08K 2003/2227; C08K 2003/265; C01P 2002/50; C01P 2004/61; C08K 7/08

(57) ABSTRACT

A filler composition comprising fibrous basic magnesium sulfate particles and non-fibrous inorganic micro-particles having an average particle diameter in the range of 0.001 to 0.5 μm in a ratio by weight in the range of 100:0.001 to 100:50, is used for providing a molded resin product which shows impact resistance and rigidity balanced at a high level.

### FIELD OF THE INVENTION

This invention relates to a filler composition and particularly relates to a filler composition which can be used for improving various physical characteristics of a molded olefin resin product.

### BACKGROUND OF THE INVENTION

Polyolefin resins such as a polypropylene resin are widely used for manufacturing exterior and interior parts of automobiles, exterior parts of household electric apparatuses such as electric refrigerators and electric washing machines, and a variety of molded products such as trays, shelf boards and wrapping sheets.

The polyolefin resins are generally utilized in the form of polyolefin resin compositions containing fillers to improve such physical properties as rigidity and impact resistance. The fillers generally employed for these purposes are fibrous inorganic fillers or non-fibrous inorganic fillers.

Patent Publication 1 (JP 2009-167407A) discloses a polypropylene resin composition that can be molded with less mold-staining and less troubles so as to give a molded product showing high antistatic properties as well as high light-resistance with good moldability. The molded product shows good balance between rigidity and impact resistance, and has good appearance with less flow marks. The disclosed polypropylene resin composition comprises 99 to 60 weight parts of a polymer of poly-propylene group, 1 to 40 weight parts of an inorganic filler (or inorganic filler material) having an average particle diameter of 0.01 to 100 μm, and 0.05 to 5 weight parts of a specific light stabilizer of the hindered amine type. In this publication, there are described non-fibrous inorganic fillers, fibrous inorganic fillers and their mixtures as inorganic fillers.

Patent Publication 2 (JP 2015-13978A) discloses a filler composition that can be incorporated into thermo-setting resins such as epoxy resin in which the filler composition comprises an inorganic fiber and spherical silica particles having a volume-average particle diameter of 0.01 to 5 μm. This publication has such description that resin compositions containing this filler composition show good fluidity, and further describes examples of the inorganic fibers such as carbonaceous fibers, fibers comprising carbonaceous material as a main component, glass, or fibers comprising glass as a main component.

Recently, it is desired that automobiles have increased light-weight body for decreasing fuel consumption. For instance, exterior parts of automobiles such as bumpers are studied to reduce their thicknesses for decreasing their weights. However, the bumpers of automobiles are required, even in the case that their thicknesses are reduced, to have high impact-resistance and high rigidity for keeping the bumpers from breakage when the bumpers are brought into contact with other automobiles or other solid materials, and further for keeping from deformation under pressures given by forces applied from the outside. However, since the molded product of the polypropylene resin that is widely used for manufacturing bumpers of automobiles shows a relationship of trade-off between its impact resistance and its rigidity. Therefore, it is known that if one characteristic increases, another characteristic likely decreases.

The inventors of the invention studied fillers described in each of the Patent Publications 1 and 2 for the use as fillers for polyolefin resins.

As a result of the studies, the inventors have found that molded products having a thin thickness such as bumpers of automobiles manufactured using polyolefin resin containing fillers described in these patent publications hardly show such high impact resistance as required for the bumpers of automobiles, without decrease of rigidity.

Accordingly, it is a primary object of the invention to provide a filler composition that is a favorably employable for incorporation into polyolefin resins to be used for giving such molded resin products as bumpers of automobiles which are required to have impact resistance and rigidity both at a high level.

The more specific object is to provide a filler composition favorably employable for producing polyolefin resin products such as polypropylene resin products which are increased in their impact resistance with no decrease of rigidity.

It is a secondary object of the invention to provide a filler composition that is a favorably employable for incorporation into polyolefin resins to be used for giving interior members such as instrumental panels of automobiles, which are desired to have a less thickness and a light weight.

### SUMMARY OF THE INVENTION

It has been now found by the inventors that a polyolefin resin composition comprising a polyolefin resin such as polypropylene resin, fibrous basic magnesium sulfate particles and non-fibrous inorganic micro-particles having an average particle diameter in the range of 0.001 to 0.5 μm in a weight ratio of 100:0.001 to 100:50 is employable for manufacturing molded products which show prominently increased Izod impact strength without decreasing flexural modulus. Izod impact strength is regarded as an indication of impact resistance, and the flexural modulus is regarded as an indication of rigidity.

Accordingly, the present invention provides a filler composition comprising fibrous basic magnesium sulfate particles and non-fibrous inorganic micro-particles having an average particle diameter in the range of 0.001 to 0.5 μm in a weight ratio in the range of 100:0.001 to 100.50.

Preferred embodiments of the filler compositions of the invention are described below.

(1) The non-fibrous inorganic micro-particles are non-fibrous inorganic micro-particles having an aspect ratio of not more than 2, such as particles of inorganic material selected from the group consisting of metal oxides, metal hydroxides and metal carbonates.

(2) The non-fibrous inorganic micro-particles are non-fibrous inorganic micro-particles having an aspect ratio of not more than 2, such as particles of inorganic material selected from the group consisting of aluminum oxide, magnesium oxide, magnesium hydroxide and calcium carbonate.

(3) The non-fibrous inorganic micro-particles are other than spherical silica particles.

(4) The filler composition is for incorporation into a polyolefin resin.

The fibrous basic magnesium sulfate particles and non-fibrous inorganic micro-particles comprised in the filler of the invention can be incorporated into a polyolefin resin under such conditions that the polyolefin resin and fibrous basic magnesium sulfate particles are contained in a weight ratio of 99:1 to 50:50, and the non-fibrous inorganic micro-particles are contained in an amount of 0.001 to 50 weight parts per 100 weight parts of the fibrous basic magnesium sulfate particles, and/or in an amount of 0.0002 to 10 weight parts per 100 weight parts of resin. Thus formulated polyolefin resin compositions can be used for manufacturing molded products having excellent physical characteristics.

### EFFECTS OF THE INVENTION

Molded products of a polyolefin resin composition containing the filler composition of the invention have both of high impact resistance and high rigidity. Accordingly, these molded products are favorably employable as exterior members of automobiles such as bumpers. Further, the molded products of a polyolefin resin composition containing the filler composition of the invention are also favorably employable as interior members of automobiles such as instrument panels.

### EMBODIMENTS OF THE INVENTION

The filler composition of the invention comprises a fibrous basic magnesium sulfate particles and non-fibrous inorganic micro-particles having an average particle diameter in the range of 0.001 to 0.5 μm. The non-fibrous inorganic micro-particles are preferably dispersed and attached onto surfaces of the fibrous basic magnesium sulfate particles. The non-fibrous inorganic micro-particles are contained in an amount of 0.001 to 50 weight parts, preferably 0.001 to 20 weight parts, more preferably 0.001 to 8 weight parts, most preferably 0.005 to 2 weight parts, per 100 weight parts of the fibrous basic magnesium sulfate particles.

The fibrous basic magnesium sulfate particles generally have an average longer diameter in the range of 5 to 50 μm, preferably 10 to 30 μm, and generally have an average shorter diameter in the range of 0.1 to 2.0 μm, preferably 0.5 to 1.0 μm. An average aspect ratio (average longer diameter/average shorter diameter) generally is 2 or more, preferably 5 or more, more preferably in the range of 5 to 50. The average longer diameter and average shorter diameter of the fibrous basic magnesium sulfate particles are values determined and averaged on 1,000 particles seen in an enlarged image obtained by means of a scanning electro-microscope (SEM).

The non-fibrous inorganic micro-particles employed in the invention have an average particle diameter (average diameter of primary particles) in the range of 0.001 to 0.5 μm (1 nm to 500 nm), preferably 0.002 to 0.2 μm (2 nm to 200 nm), more preferably 0.005 to 0.1 μm (5 nm to 100 nm). The average particle diameter of the non-fibrous inorganic micro-particles is generally in the range of ½ to 1/1,000 preferably ½ to 1/500, more preferably ⅕ to 1/500, per an average shorter diameter of the fibrous basic magnesium sulfate particles. The average particle diameter of the non-fibrous inorganic micro-particles can be determined by image analysis of SEM image or by means of a particle size distribution analyzer.

Examples of the non-fibrous inorganic micro-particles include aluminum oxide (alumina) particles, magnesium oxide (magnesia) particles, magnesium hydroxide particles, basic magnesium carbonate particles and calcium carbonate particles. The non-fibrous inorganic micro-particles preferably are particles having an average aspect ratio (average longer diameter/average shorter diameter) of less than 2, preferably less than. 1.5.

The filler composition of the invention can be prepared, for example, by mixing the fibrous basic magnesium sulfate particles and the non-fibrous inorganic micro-particles. The mixing can be performed by dry mixing by the use of a dry mixer or by wet mixing by the use of a wet mixer using a liquid dispersing medium. The wet mixing is preferred to uniformly, mix the fibrous basic magnesium sulfate particles with the non-fibrous inorganic micro-particles.

The dry mixer for performing the dry mixing can be high speed-rotation mills (e.g., cutter mill, cage mill, hammer mill, pin mill, turbo mill, and centrifugal classification mill) and a jet mill.

The dispersing medium for the use in a wet mixer can be water, lower alcohols and ketones. The wet mixing can be performed by mixing a dispersion of the fibrous basic magnesium sulfate particles with a dispersion of the non-fibrous inorganic micro-particles; a dispersion of the fibrous basic magnesium sulfate particles with powdery non-fibrous inorganic micro-particles; powdery fibrous basic magnesium sulfate particles with a dispersion of the non-fibrous inorganic micro-particles; and powdery fibrous basic magnesium sulfate particles, powdery non-fibrous inorganic micro-particles and a liquid medium. The wet mixer can be a stirrer or a medium stirring mill. Further, there are employed rotating dispersers such as a ultrasonic disperser and a homomixer, a high pressure homomixer, and a wet jet mill.

The filler composition of the invention can be surface-treated with a coupling agent for increasing affinity to the resins. Examples of the coupling agents include silane coupling agents (i.e., alkoxysilanes having functional groups selected from those consisting of phenyl, vinyl, epoxy, methacryl, amino, ureido, mercapto, isocyanate and acryl).

The filler composition of the invention can be incorporated into either of thermoplastic resins and thermosetting resins. Examples of the thermoplastic resins include polyolefin resins, polyester resins, polyamide resins and polyacryl resins. Examples of the polyolefin resins include an ethylene homopolymer, a propylene homopolymer, copolymers of ethylene and propylene, copolymers of ethylene and α-olefins, and copolymers of propylene and α-olefins. Examples of the polyester resins include polyethylene terephthalate and polybutylene terephthalate. Examples of the polyamide resins include 6-nylon and 6,6-nylon. Examples of the polyacryl resins include poly(methyl methacrylate). In addition, the filler composition can be incorporated into polycarbonate and polyether imide. Examples of the thermosetting resins include epoxy resins, phenol resins and urethane resins.

The filler composition of the invention can be incorporated into resins in a weight ratio (in terms of resin:filler) in the range of 99:1 to 50:50, preferably 99:1 to 70:30. The filler composition of the invention can be incorporated into a resin by means of kneaders such as a uniaxial melt-kneading extruder, a double screw melt-kneading extruder or a bambury mixer.

The resin can contain additives such as oxidation inhibitors, UV absorbers, pigments, antistatic agents, rust inhibitors, flame retardants, lubricants, neutralizing agents, foaming agents, plasticizing agents, anti-foaming agent, and cross-linkers, in addition to the filler composition of the invention. These additives are known to improve the physical characteristics of the resin compositions.

The resin composition containing the filler composition of the invention can be molded by known molding methods. Examples of the known molding methods include injection molding, extrusion, calendaring, blow molding, expansion molding, and drafting.

### EXAMPLES

### Reference Example

### Preparation of Fibrous Basic Magnesium Sulfate Particles

1.5 L of an aqueous fibrous basic magnesium sulfate slurry (solid content: 2 weight 5, average fiber length: 15 μm, average fiber diameter: 0.5 μm, average aspect ratio: 30) was filtered under vacuum over a Büchner funnel to give 120 g of water-containing fibrous basic magnesium sulfate product (water content: 75 weight %).

The resulting water-containing fibrous basic magnesium sulfate product was processed in an extrusion granulator to give granules having a diameter of 2.4 mm and dried in a box dryer under heating at 160° C. for 24 hours to produce a basic magnesium sulfate powder (granular fibrous basic magnesium sulfate).

### Comparison Example

85 Weight parts of polypropylene resin [MER (temp. 230° C., load 2.16 kg) : 52 g/min.) and 15 weight parts of fibrous basic magnesium sulfate particles produced in Reference Example were mixed. The resulting mixture was melt-kneaded and extruded at a temperature of 230° C., rotation of screws: 90 r.p.m., by means of a double screw melt-kneading extruder (L/D=25, available from Imoto Seisakusho Co., Ltd.) to give a melt-kneaded product in the form of strands. The strands were cut to give pellets of a polypropylene resin composition containing the fibrous basic magnesium sulfate particles.

The resulting pellets of polypropylene resin composition was introduced into a small-sized injection molding machine (Handy Dry, manual-operated injection molding machine, available from Shinko Selbic, Co. Ltd.) to produce specimens (strips, 5 mm (width)×2 mm(thickness)×50 mm (length)).

The specimens were subjected to measurements of Izod impact strength and flexural modulus. The measurement results are set forth in Table 1.

The Izod impact strength was measured by means of an Izod impact tester (available from Maizu Tester Co., Ltd.).

The flexural modulus was measured by means of an electric measuring stand (MX-500N, Imada Corporation) and a digital force gauge (ZTA-500N, available from Imada Corporation) at a load rate of 10 mm/min., and distance between supports: 40 mm.

### Example 1

Into 1.5 L of a fibrous basic magnesium sulfate slurry (solid content: 2.0 weight 5, average fiber length: 15 μm, average fiber diameter: 0.5 μm, average aspect ratio: 30) was poured a slurry containing 0.45 g of alumina nano-particles (solid content: 10 weight %, average particle size: 31 nm, aspect ratio: 1.18), and the resulting mixture was stirred for 10 minutes and filtered under vacuum over a Büchner funnel to give a water-containing product containing fibrous basic magnesium sulfate and alumina particles. Thereafter, the resulting water-containing product was processed in the manner described in Reference Example to give a filler composition comprising fibrous basic magnesium sulfate and alumina nano-particles.

The procedures described in Comparison Example were repeated except for substituting the fibrous basic magnesium sulfate particles with the above-obtained filler composition to produce pellets of polypropylene resin composition containing the above-obtained filler composition.

The procedures of Comparison Example were repeated using the pellets of a polypropylene resin composition to measure Izod impact resistance and flexural modulus.

The results of measurements are set forth in Table 1.

### Example 2

Into 500 cc-volume of a plastic cylindrical vessel were poured 15 g of fibrous basic magnesium sulfate particles and 0.0225 g of high purity ultra-micro magnesium oxide particles (500 A, average diameter: 52 nm, aspect ratio: 1.21, available from Ube Material Industries, Ltd.) The resulting mixture was stirred under rotation for 10 minutes to give a filler composition comprising fibrous basic magnesium sulfate particles and high purity ultra-micro magnesium oxide particles.

The procedures described in Comparison Example were repeated except for substituting the fibrous basic magnesium sulfate particles with the above-obtained filler composition to produce pellets of polypropylene resin composition containing the above-obtained filler composition.

The procedures of Comparison Example were repeated using the pellets of a polypropylene resin composition to measure Izod impact resistance and flexural modulus.

The results of measurements are set forth in Table 1.

### Example 3

Into 500 cc-volume of a plastic cylindrical vessel were poured 15 g of fibrous basic magnesium sulfate particles and 0.0225 g of high purity ultra-micro magnesium hydroxide particles (500 H, average diameter: 72 nm, aspect ratio: 1.20, available from Ube Material industries, Ltd.). The resulting mixture was stirred under rotation for 10 minutes to give a filler composition comprising fibrous basic magnesium sulfate particles and high purity ultra-micro magnesium hydroxide particles.

The procedures described in Comparison Example were repeated except for substituting the fibrous basic magnesium sulfate particles with the above-obtained filler composition to produce pellets of polypropylene resin composition containing the above-obtained filler composition.

The procedures of Comparison Example were repeated using the pellets of a polypropylene resin composition to measure Izod impact resistance and flexural modulus.

The results of measurements are set forth in Table 1.

### Example 4

Into 500 cc-volume of a plastic cylindrical vessel were poured 15 g of fibrous basic magnesium sulfate particles and 0.0225 g of high purity ultra-micro calcium carbonate particles (CS3N-A30, average diameter: 70 nm, aspect ratio: 1.35, available from Ube Material Industries, Ltd.). The resulting mixture was stirred under rotation for 10 minutes to give a filler composition comprising fibrous basic magnesium sulfate particles and high purity ultra-micro calcium carbonate particles.

The procedures described in Comparison Example were repeated except for substituting the fibrous basic magnesium sulfate particles with the above-obtained filler composition to produce pellets of polypropylene resin composition containing the above-obtained filler composition.

The procedures of Comparison Example were repeated using the pellets of a polypropylene resin composition to measure Izod impact resistance and flexural modulus.

The results of measurements are set forth in Table 1.

TABLE 1

| | Izod impact | Flexural modulus |
|---|---|---|
| | strength (kJ/m²) | (GPa) |
| Com.Ex. | 2.1 | 2.8 |
| Example 1 | 3.0 | 2.8 |
| Example 2 | 2.4 | 2.9 |
| Example 3 | 2.6 | 3.0 |
| Example 4 | 2.7 | 2.7 |

The results of measurements set forth in Table 1 indicate that molded products made from polyolefin resin compositions which comprises a filler composition of the invention show enhanced. Izod impact strength as compared with molded products made from the polypropylene resin compositions containing only a polyolefin resin and fibrous basic magnesium sulfate particles, keeping the flexural modulus.

What is claimed is:

1. A filler composition comprising fibrous basic magnesium sulfate particles and non-fibrous inorganic micro-particles having an average particle diameter in the range of 0.001 to 0.5 μm, in a ratio by weight in the range of 100:0.001 to 100:50, in which the non-fibrous inorganic micro-particles are dispersed and attached onto surfaces of the fibrous basic magnesium sulfate particles.

2. The filler composition of claim 1, wherein the non-fibrous inorganic micro-particles are non-fibrous inorganic micro-particles having an aspect ratio of not more than 2, which are particles of inorganic material selected from the group consisting of metal oxides, metal hydroxides and metal carbonates.

3. The filler composition of claim 1, wherein the non-fibrous inorganic micro-particles are non-fibrous inorganic micro-particles having an aspect ratio of not more than 2, which are particles of inorganic material selected from the group consisting of aluminum oxide, magnesium oxide, magnesium hydroxide and calcium carbonate.
